(19) United States
(12) Patent Application Publication
(10) Pub. No.: US 2023/0003856 A1
(43) Pub. Date: Jan. 5, 2023

(54) TIME-OF-FLIGHT SENSING FOR HORTICULTURE

(71) Applicant: SIGNIFY HOLDING B.V., EINDHOVEN (NL)

(72) Inventors: Harry BROERS, 's-HERTOGENBOSCH (NL); Marc Andre DE SAMBER, LOMMEL (BE)

(21) Appl. No.: 17/781,733

(22) PCT Filed: Nov. 23, 2020
(86) PCT No.: PCT/EP2020/083044

§ 371 Date: Jun. 2, 2022

(30) Foreign Application Priority Data
Dec. 3, 2019 (EP) 19213068.0

(51) Int. Cl. G01S 7/499; G01S 17/10; G01S 17/894; A01G 9/24; G01S 17/00; G01S 7/48; G01S 7/481; G01S 7/484

(52) U.S. Cl. CPC G01S 7/499; G01S 17/10; G01S 17/894; A01G 9/24; G01S 17/003; G01S 7/4808; G01S 7/4816; G01S 7/4815; G01S 7/484

(57) ABSTRACT

The invention provides a sensing system (1000), e.g. for agricultural application, comprising a radiation generator (100), a sensing apparatus (200), and a control system (300) functionally coupled to the radiation generator (100) and the sensing apparatus (200), wherein the sensing system (1000) has one or more time-of-flight sensing modes of operation, wherein the generator (100) is configured to generate a pulse of radiation (111) in the one or more time-of-flight sensing modes of operation, and wherein the sensing apparatus (200) is configured to sense wavelength dependent spectral intensities of radiation received by the sensing apparatus (200) as a function of time in the one or more time-of-flight sensing modes, to provide a sensing system signal; wherein the sensing system signal is indicative of the wavelength dependent spectral intensity distribution of the received radiation as a function of time in the one or more time-of-flight sensing modes.

### FIELD OF THE INVENTION

The invention relates to a sensing system (and its use). The invention also relates to an agricultural facility (and its use). Yet further, the invention relates to a plant monitoring method. The invention also relates to computer program product (for executing such plant monitoring method, e.g. with the sensing system).

### BACKGROUND OF THE INVENTION

Methods, devices and system for detection, sensing, and identification of objects are known in the art. WO2018/194920, for instance, describes methods, devices and systems for detection, sensing and identification of objects using modulated polarized beams. An example polarization sensitive device includes an illumination source, and a modulator coupled to the illumination source to produce output beams in which polarization states or polarization parameters of the output beams are modulated to produce a plurality of modulated polarized beams. The device further includes a polarization sensitive detector positioned to receive a reflected portion of modulated polarized beams after reflection from an object and to produce information that is indicative of modulation and polarization states of the received beams. According to WO2018/194920, the information can be used to enable a determination of a distance between the polarization sensitive device and the object, or a determination of a polarization-specific characteristic of the object.

### SUMMARY OF THE INVENTION

In large industrial horticulture installations, such as greenhouses and city farms, but also in open air horticulture, there is a trend to make use of automated inspection and handling as a replacement or support to the farmer and human workers. This automation is becoming required and almost mandatory in future because of e.g. the facts that observing, estimating (e.g. on ripeness, onset of disease, . . . ), handling (e.g. harvesting) of crops and fruits is highly time consuming, manual work is highly expensive and may require expert people. Further, even experts can make mistakes and may not be stable and objective in their analysis or actions. Further, when 24/7 monitoring is required it may be more comfortable to have the monitoring done at least part of the time by a machine. Hence, next to the use of automated harvesting and crop processing (e.g. spraying) machines, an automated plant and crop/fruit sensing may be desirable. Prior art systems, however, may have less functionalities than desired. Hence, it is an aspect of the invention to provide an alternative sensing system (and/or agricultural facility and/or (plant) monitoring method, and/or computer program product), which preferably further at least partly obviate one or more of above-described drawbacks. The present invention may have as object to overcome or ameliorate at least one of the disadvantages of the prior art, or to provide a useful alternative.

In a first aspect, the invention provides a sensing system, especially for agricultural application, comprising a radiation generator (“generator”) and a sensing apparatus (which may be functionally coupled to the generator). Further, the sensing system may comprise a control system, which may especially be functionally coupled to the radiation generator and the sensing apparatus (which may also be indicated as “sensor”). Especially, in embodiments the sensing system may have one or more time-of-flight sensing modes of operation, wherein the generator is configured to generate a pulse of radiation in the one or more time-of-flight sensing modes of operation. Especially, the sensing apparatus may be configured to sense radiation coming from an object being sensed as a function of time in the one or more time-of-flight sensing modes, to provide a sensing system signal. In more specific embodiments, the sensing apparatus may be configured to sense (wavelength dependent) spectral intensities, such as wavelength dependent spectral intensity distributions, of (coming) radiation received by the sensing apparatus as a function of time in the one or more time-of-flight sensing modes, to provide a sensing system signal. Especially, the spectral intensities, such as wavelength dependent spectral intensity distributions, may be spectral power distributions. The sensing system signal is indicative of the wavelength dependent spectral intensity distribution of the received radiation as a function of time in the one or more time-of-flight sensing modes. Hence, especially in embodiments the invention provides (thus) a sensing system (especially for agricultural application) comprising a radiation generator, a sensing apparatus (functionally coupled to the generator), and a control system functionally coupled to the radiation generator and the sensing apparatus, wherein the sensing system has one or more time-of-flight sensing modes of operation, wherein the generator is configured to generate a pulse of radiation in the one or more time-of-flight sensing modes of operation, and wherein the sensing apparatus may be configured to sense radiation coming from an object being sensed as a function of time in the one or more time-of-flight sensing modes, to provide a sensing system signal. Further, especially in embodiments the invention provides (thus) a sensing system (especially for agricultural application) comprising a radiation generator, a sensing apparatus (functionally coupled to the generator), and a control system functionally coupled to the radiation generator and the sensing apparatus, wherein the sensing system has one or more time-of-flight sensing modes of operation, wherein the generator is configured to generate a pulse of radiation in the one or more time-of-flight sensing modes of operation, and wherein the sensing apparatus is configured to sense (wavelength dependent) spectral intensities, such as wavelength dependent spectral intensity distributions, of radiation received by the sensing apparatus as a function of time in the one or more time-of-flight sensing modes, to provide a sensing system signal.

Furthermore: The sensing system signal may be useful as such, for instance to get a better status overview of the object(s). However, the sensing system signal may also be used to control (another) device (or apparatus or system). Hence, the invention may additionally provide that the sensing system is functionally coupled to an agricultural device, wherein the agricultural device comprises a lighting device for illuminating a plant or plant part with a light recipe, wherein the control system controls the agricultural device to illuminate the plant or plant part with the light recipe in dependence of the sensing system signal.

With such sensing system(s) the invention provides in embodiments a time-of-flight camera with multispectral illumination for horticultural applications. The active illumination of the time-of-flight camera may in embodiments use multiple wavelengths to acquired range information used to get shape properties of plants. This may in embodiments be combined with capturing and analyzing the intensity signal of different wavelengths which may contain information about plant health and development and can be used to e.g. classify different plant parts and/or determine the status of these plant parts. It may be possible to earlier detect diseases and/or to get a more accurate status of the plants or of individual plants. In this way, treatment and/or other actions, like pruning, disease management or harvesting may, also be executed more effectively. The term “range information” may especially refer to distance information.

As indicated above, the sensing system may especially be used for agricultural applications, like horticulture applications. The term “agriculture” may especially refer to the science and art of cultivating plants and livestock. Herein, the term “agriculture” may especially refer to the science and art of cultivating plants. This may be indoors or outdoors agriculture. This may be agriculture in greenhouses, in closed plant factories, etc. etc. This may be based on daylight only, on a combination of daylight and artificial light, or on artificial light only. The term “agriculture” may especially at least include “horticulture”. Amongst others, the invention is especially related to horticulture applications. The term “horticulture” relates to (intensive) plant cultivation for human use and is very diverse in its activities, incorporating plants for food (fruits, vegetables, mushrooms, culinary herbs) and non-food crops (flowers, trees and shrubs, turf-grass, hops, grapes, medicinal herbs). Horticulture is the branch of agriculture that deals with the art, science, technology, and business of growing plants. It may include the cultivation of medicinal plants, fruits, vegetables, nuts, seeds, herbs, sprouts, mushrooms, algae, flowers, seaweeds and non-food crops such as grass and ornamental trees and plants. Here, the term “plant” is used to refer essentially any species selected from medicinal plants, vegetables, herbs, sprouts, mushrooms, plants bearing nuts, plants bearing seeds, plants bearing flowers, plants bearing fruits, non-food crops such as grass and ornamental trees, etc.

Herein, the term “plant” is used for essentially all stages. The term “plant part” may refer to root, stem, leaf, fruit (if any), etc. The term “horticulture” relates to (intensive) plant cultivation for human use and is very diverse in its activities, incorporating plants for food (fruits, vegetables, mushrooms, culinary herbs) and non-food crops (flowers, trees and shrubs, turf-grass, hops, grapes, medicinal herbs). Horticulture is the branch of agriculture that deals with the art, science, technology, and business of growing plants. It may include the cultivation of medicinal plants, fruits, vegetables, nuts, seeds, herbs, sprouts, mushrooms, algae, flowers, seaweeds and non-food crops such as grass and ornamental trees and plants. Here, the term “plant” is used to refer essentially any species selected from medicinal plants, vegetables, herbs, sprouts, mushrooms, plants bearing nuts, plants bearing seeds, plants bearing flowers, plants bearing fruits, non-food crops such as grass and ornamental trees, etc. Even more especially, the term “plant” is used to refer essentially any species selected from medicinal plants, vegetables, herbs, sprouts, plants bearing nuts, plants bearing seeds, plants bearing flowers, plants bearing fruits, non-food crops. The terms “horticulture” and “plant” may also refer to one or more of Cannabis and Papaver (especially Papaver somniferum, also indicated as “opium poppy” or “bread seed poppy”).

The term “crop” is used herein to indicate the horticulture plant that is grown or was grown. Plants of the same kind grown on a large scale for food, clothing, etc., may be called crops. A crop is a non-animal species or variety that is grown to be harvested as e.g. food, livestock fodder, fuel, or for any other economic purpose. The term “crop” may also relate to a plurality of crops. Horticulture crops may especially refer to food crops (tomatoes, peppers, cucumbers and lettuce), as well as to plants (potentially) bearing such crops, such as a tomato plant, a pepper plant, a cucumber plant, etc. Horticulture may herein in general relate to e.g. crop and non-crop plants. Examples of crop plants are Rice, Wheat, Barley, Oats, Chickpea, Pea, Cowpea, Lentil, Green gram, Black gram, Soybean, Common bean, Moth bean, Linseed, Sesame, Khesari, Sunhemp, Chillies, Brinjal, Tomato, Cucumber, Okra, Peanut, Potato, Corn, Pearlmillet, Rye, Alfalfa, Radish, Cabbage, Lettuce, Pepper, Sunflower, Sugarbeet, Castor, Red clover, White clover, Safflower, Spinach, Onion, Garlic, Turnip, Squash, Muskmelon, Watermelon, Cucumber, Pumpkin, Kenaf, Oilpalm, Carrot, Coconut, Papaya, Sugarcane, Coffee, Cocoa, Tea, Apple, Pears, Peaches, Cherries, Grapes, Almond, Strawberries, Pine apple, Banana, Cashew, Irish, Cassava, Taro, Rubber, Sorghum, Cotton, Triticale, Pigeonpea, and Tobacco. Especial of interest are tomato, cucumber, pepper, lettuce, water melon, papaya, apple, pear, peach, cherry, grape, and strawberry.

The term “plant” may also refer to a seed, or to a seedling. The term “plant” may thus in general refer to any of the stages from seed to (mature) plant. The term “plant” may also refer to a plurality of (different) plants.

Especially, the sensing system comprises a radiation generator and a sensing apparatus. Further, the sensing system may especially also comprise a control system.

The radiation generator is configured to generate radiation (like one or more of UV, visible and (N)IR).

In embodiments, the radiation generator may be configured to generate narrow-band radiation, such as especially essentially monochromatic light. With monochromatic light, (unwanted) wavelength dependent penetration depths and/or wavelength dependent transmissions and/or wavelength dependent reflections may be prevented. This may allow a relatively easy processing of the radiation that returns from an object and which may be sensed by the sensing apparatus.

In embodiments, the radiation generator may comprise a solid state light source, such as a light emitting diode or a laser diode.

In embodiments, the radiation generator may comprise a plurality of such essentially monochromatic light sources. In such embodiments, it may be possible to subject the object to different wavelengths. From the detected radiation, information may be derived that may be wavelength dependent. For instance, penetration of radiation and/or transmission of radiation and/reflection of radiation and/or scattering of radiation and/or fluorescence (due to irradiation with the radiation) may e.g. be dependent upon the plant part, the stage of growing, the presence of a disease, the health of the plant, etc. etc., and may thus be wavelength dependent, as each may have or lead to different optical properties, such as e.g. selected from transmission, reflection, and fluorescence.

In embodiments, the radiation generator may comprise a broad band emitter and one or more optics to select narrow bands, such as gratings, refractive elements, and/or optical filters. Also in such embodiments, the radiation generator may thus be configured to generate essentially monochromatic light (of essentially a single wavelength). The term “narrow band” may refer the bands having a full width half maximum of equal to or less than 50 nm; the term “broad band” may refer to bands having a full width half maximum of more than 50 nm.

In embodiments, the radiation generator may comprise an optical amplifier. An optical amplifier is a device that amplifies an optical signal directly, without the need to first convert it to an electrical signal. The optical amplifier may comprise a laser amplifier, such as a solid state amplifier or a doped fiber amplifier, or a semiconductor optical amplifier, etc. With an optical amplifier, an essentially monochromatic wavelength may be chosen, though the wavelength may be chosen from a broader range, allowing tunability. In such embodiments, it may be possible to subject the object to different wavelengths. From the detected radiation, information may be derived that may be wavelength dependent (see also above).

Hence, in embodiments the radiation generator may be configured to generate essentially monochromatic light (of essentially a single wavelength). In other embodiments, the radiation generator may be configured to generate essentially monochromatic light at two or more wavelengths. This may be simultaneously. However, especially this may be sequentially.

In yet other embodiments, the radiation generator may be configured to generate polychromatic light. Especially, this may be useful when the sensing apparatus may also be configured to sense a plurality of different wavelengths. In such embodiments, the impact of radiation of different wavelengths on the object may be sensed (over time).

Alternatively or additionally, the radiation generator may be configured to generate radiation with a specific polarization. As indicated above, penetration of radiation and/or transmission of radiation and/reflection of radiation and/or scattering of radiation and/or fluorescence (due to irradiation with the radiation) may e.g. be dependent upon the plant part, the stage of growing, the presence of a disease, the health of the plant, etc. etc., and may thus be polarization dependent, as each may have or lead to different polarization dependent optical.

To this end, the radiation generator may comprise a radiation emitter configured to generate radiation having a specific polarization. Alternatively or additionally, the radiation generator may comprise a radiation emitter that generates unpolarized radiation, and one or more optics to impose a polarization to the radiation.

In specific embodiments, the radiation generator may be configured to generate radiation with two or more different polarizations, like linearly polarized light and circular polarized light, or left polarized light and right polarized light, etc. In such embodiments, it may be possible to subject the object to different polarizations. From the detected radiation, information may be derived that may be polarization dependent. For instance, the detection of chiral molecules, such as sugars, proteins, etc., may be facilitated. These may e.g. be detected by the rotation of the plane of polarization of linearly polarized light.

In embodiments, the polarization of the radiation provided by the radiation generator may be differ over time and/or differ over spatial position over an emission window of the radiation generator.

The radiation generator may be configured to provide the radiation continuously. Especially, however, the radiation generated may be configured to provide the radiation in a pulsed way. Hence, the radiation may be provided in a pulsed way, with pulses having identical lengths and intensities, or pulses differing in one or more of time length (pulse width) and intensity.

Especially, in embodiments the radiation generator may be configured to provide a plurality of pulses of radiation wherein the wavelength(s) of the radiation in the pulses of radiation differs. In this way, the impact of radiation having different wavelengths (or different wavelengths distributions) may be sensed over time (in embodiments of the ToF modes).

A plurality of pulses of two or more different radiations will in general be generated consecutively, with (at least) sensing time in between, as will be known to a person skilled in the art. Two or more pulses may e.g. differ in wavelength and/or polarization.

Especially for measuring in a time-of-flight mode, it may be desirable to generate the radiation in a pulsed way. Even more especially, the pulses may have a relatively short time length. For instance, the pulses may have pulse width equal to or less 100 ns (nano seconds), such especially equal to or less than 50 ns, such as equal to or less than 2 ns. Even more especially, the pulse width may be equal to or less than 1 ns, such as equal to or less than 100 ps (pico seconds), such especially equal to or less than 10 ps, such as equal to or less than 1 ps. Yet even more especially, the pulse width may be equal to or less than 100 fs (femto seconds), such especially equal to or less than 10 fs, such as equal to or less than 1 fs. A pulsed laser based 1D ToF system may in embodiments include a laser pulse transmitter, (necessary) optics, (two) receiver channels and a TDC (Time-to-Digital Converter) or a highspeed ADC (Analog-to-Digital Converter). The laser pulse transmitter may emit a short optical pulse (such as in embodiments typically 2 to 50 ns) to an object and the transmission event may be defined either optically, by detecting a fraction of the pulse, or electrically, from the drive signal of the laser diode.

As indicated above, the generator is especially configured to generate a pulse of radiation (in the one or more time-of-flight sensing modes of operation). The term “pulse of radiation” may in embodiments refer to a pulse which may be defined by two (infinitesimal small) periods of zero radiation intensity. However, term “pulse of radiation” may also refer to a modulation on a background signal; in such embodiments the pulse may be defined by two (infinitesimal small) minima in the radiation intensity. Further, the term “pulse of radiation” may also refer to a plurality of such pulses. In embodiments, a plurality of pulses may be generated that are identical. In yet other embodiments, a plurality of pulses may be generated of which two or more may differ. Pulses may differ (or be identical) in pulse width and pulse height. When a plurality of pulses are generated, the frequency may be fixed, though this is not necessarily the case.

The term “radiation generator” may in embodiments also refer to a plurality of (different) radiation generators.

As indicated above, the sensing system may further comprise a sensing apparatus.

The sensing apparatus may be configured to sense a specific wavelength.

The sensing apparatus may also comprise a sensing device configured to sense a plurality of wavelengths and one or more optics to select specific wavelength to be sensed, such as gratings, refractive elements, and/or optical filters. For instance, in specific embodiments the sensing apparatus may be configured to measure a spectral intensity distribution of radiation, such as a spectral power distribution.

Hence, in specific embodiments the sensing apparatus may be able to sense (and separate the signals of) radiations having different wavelengths, such as polychromatic light. Especially, in specific embodiments the sensing apparatus may be able to sense radiations having different wavelengths, such as polychromatic light, over time (see also below). This may be useful in the time-of-flight modes. Further, this may be useful for measuring luminescence and/or this may be useful for measuring the radiation of a radiation generator configured to generate polychromatic light. As indicated above, especially this may be useful when the sensing apparatus is configured to sense a plurality of different wavelengths. In such embodiments, the impact of radiation of different wavelengths on the object may be sensed (over time).

The sensing apparatus may be configured to sense a specific polarization, i.e. radiation having a specific polarization.

The sensing apparatus may also comprise a sensing device configured to sense a plurality of different polarizations (i.e. different radiations, differing in at least the type of polarization), and one or more optics to select specific polarizations.

In embodiment, the polarization of the radiation sensed by the sensing apparatus may be differ over time and/or differ over spatial position over an entrance window of the sensing apparatus.

Especially, the sensing apparatus may be configured to measure the radiation time dependent. In this way, e.g. time of flight measurements may be executed.

As indicated above, the sensing apparatus may especially be configured to sense radiation from the object. In embodiments, this radiation may be the same radiation as provided by the radiation generator, as radiation may be reflected or transmitted. Alternatively or additionally, in embodiments this radiation may be different as radiation may be partly absorbed. In this way, a spectral intensity distribution of the radiation emanating from the object may differ from the spectral intensity distribution of the radiation provided by the radiation generator. Alternatively or additionally, in embodiments this radiation may be different as radiation may be partly absorbed and converted into luminescence. Hence, the phrase “configured to sense radiation from the object”, and similar phrases, may refer to e.g. one or more of radiation after transmission, radiation after reflection, and radiation after absorption.

In embodiments, the term “luminescence” may refer to phosphorescence. In embodiments, the term “luminescence” may also refer to fluorescence. Instead of the term “luminescence”, also the term “emission” may be applied.

The term “sensing apparatus” may also refer to a plurality of the same or different sensing apparatus.

Especially, the sensing apparatus may be functionally coupled to the generator. A functional coupling of the sensing apparatus and the generator may e.g. be obtained via the control system. The control system can in embodiments give instructions to the generator to generate radiation, or a specific type of radiation, and also instruct the sensing apparatus to sense radiation coming from the object sensed.

The sensing apparatus and generator may be integrated in a single apparatus. Such embodiments, the sensing apparatus and generator may be configured in a single housing and/or may be mechanically coupled. In embodiments, a plurality of sensing apparatus and the generator are integrated in a single apparatus.

In yet other embodiments, the sensing apparatus and generator are not necessarily physically coupled or are physically coupled but movable relative to each other. Hence, in specific embodiments the radiation generator and the sensing apparatus may be configured movable relative to each other. In this way, e.g. the angle of incidence of the radiation on the object may be controlled. Further, this may be used to control whether or not in reflective mode and/or transmissive mode (see also below) is being sensed. The phrase “movable relative to each other” may refer to embodiments wherein one may be movable relative to the other, or embodiments wherein the other is movable relative to the one, and may in specific embodiments also refer wherein each is movable relative to the other. Here, “movable” may especially refer to translational movable or rotational movable, especially rotational moveable. In this way, the sensing apparatus and generator may be configured in different positions relative to each other.

In embodiments, the sensing apparatus and radiation generator may be configured to measure in a reflective mode. Hence, in embodiments an optical axis of the sensing apparatus and an optical axis of the radiation generator may be configured under an angle and may propagate in the same direction. This may e.g. be used for measurements of reflections and/or luminescence. Such angle may be small (or even zero); however, such angle may also be selected from essentially angle in the range of equal to 0° and smaller than 180°. For instance, when a semi-transparent mirror is applied, or other optics, in embodiments such angle may be about 0°.

In embodiments, the sensing apparatus and radiation generator may be configured to measure in a transmissive mode. Hence, in embodiments an optical axis of the sensing apparatus and an optical axis of the radiation generator may be configured under a small (or even zero) angle and may propagate in the opposite directions.

In embodiments, the radiation generator comprises a first plurality of pixels, wherein the radiation generator is configured to generate the pulse of radiation in the one or more time-of-flight sensing modes of operation in the first plurality of pixels, wherein the sensing apparatus is configured to sense wavelength dependent spectral intensities of radiation received by the sensing apparatus as a function of time in the one or more time-of-flight sensing modes via the second plurality of pixels, to provide a sensing system signal. The first plurality of pixels and the second plurality of pixels may be arranged in a checkered pattern in a same plane. Such an embodiment may be advantageous to ensure that the generated radiation, which is received back and sensed, has coupled into an object (e.g. plant), propagated through said object, and left said object at a different location. This may allow properties to be analyzed corresponding to the internal parts of said object, for example. Said checkered pattern may alternatively be an alternating pattern in a same line.

In essentially all type of configurations, luminescence (if any) may be sensed.

The phrase “radiation coming from the object”, and similar phrases, may refer to radiation downstream from the object. It may especially refer to radiation that emanates from the objects upon irradiating the object with the radiation. The radiation emanating from the object may be transmitted radiation, and/or reflected radiation, and/or luminescence. Hence, the phrase “radiation coming from the object”, and similar phrases, may in embodiments refer to radiation returning from the object or radiation being transmitted by the object.

Note that in embodiments the sensing apparatus and radiation generator may be configured to sense two or more of reflection, transmission, and luminescence. Hence, in specific embodiments the sensing apparatus and radiation generator may be configured to measure in a transmissive and reflective mode. Yet further, the radiation generator and sensing apparatus may be configured such that scattering may be sensed (by the sensing apparatus).

The terms “upstream” and “downstream” relate to an arrangement of items or features relative to the propagation of the radiation from a radiation generating means (here the especially the radiation generator), wherein relative to a first position within a beam of radiation from the radiation generating means, a second position in the beam of radiation closer to the radiation generating means is “upstream”, and a third position within the beam of radiation further away from the radiation generating means is “downstream”.

As indicated above, the sensing system may further comprise a control system functionally coupled to the radiation generator and the sensing apparatus. Especially, the control system may be configured to control the timing of providing radiation and sensing radiation. In view of the time-of-flight sensing modes, the control system may be configured to control generation of one or more radiation pulses and measuring radiation from the object. Especially, the stage of measuring radiation may be done time dependent. Hence, in embodiments the intensity at one or more wavelengths may be measured over time after generation of a pulse of radiation by the radiation generator.

Therefore, as indicated above the sensing system may comprise a radiation generator, a sensing apparatus, and a control system functionally coupled to the radiation generator and the sensing apparatus, wherein the sensing system has one or more time-of-flight sensing modes of operation.

The time-of-flight principle (ToF) may especially be a method for determining the distance between a sensor and an object, based on the time difference between the emission of a signal and its return to the sensor, after being reflected by an object. Herein, the ToF principle may alternatively or additionally also be used for determining the 3D conformation of a plant, the type of plant, different plant parts, the stage of growing, the presence of a disease, the health of the plant, etc.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, WIFI, LiFi, ZigBee, BLE or WiMAX, or another wireless technology.

The system, or apparatus, or device may execute an action in a “mode” or “operation mode” or “mode of operation”. Likewise, in a method an action or stage, or step may be executed in a “mode” or “operation mode” or “mode of operation” or “operational mode”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

As indicated above, in specific embodiments the generator is configured to generate a pulse of radiation in the one or more time-of-flight sensing modes of operation and the sensing apparatus may be configured to sense radiation coming from an object being sensed as a function of time in the one or more time-of-flight sensing modes, to provide a sensing system signal.

The sensing is especially indicative of an intensity of the sensed signal as function of the time (after providing the pulse of radiation). The sensing system signal may also be indicative of polarization of the sensed radiation and/or of the used radiation. The sensing system signal may also be indicative of the intensity of the used radiation. Further, the sensed signal may be indicative of angular distribution of the sensed radiation.

Further, the sensed signal may be indicative of the spectral intensity distribution of the sensed radiation. In such embodiments, at two or more different wavelengths the radiation (from the object) may be sensed. Hence, the sensing system signal may also be indicative of a distribution of spectral intensities or ratios between spectral intensities. The term “spectral intensity distribution” may in embodiments refer to an n*m array, wherein n≥2, and wherein in embodiments m=a*n, wherein a≥1. One row may be indicative of the wavelength, and one or more other rows may be indicative of an intensity. The intensity may be based on intensity in photons count or energy count (spectral power distribution). A row may include intensity values. Alternatively or additionally, a row may comprise processed intensity values, such as e.g. ratios of values, or derivatives, etc.

As indicated above, the term “spectral intensity distribution” may in embodiments refer to spectral power distribution.

In order to determine a spectral intensity distribution, the sensing apparatus may comprise a wavelength dependent sensor, such as a CCD camera. Hence, in embodiments the sensing apparatus may comprise a multi-pixel sensor, optionally including color filters for wavelength dependent detection.

Alternatively or additionally, the sensing apparatus may comprise a sensor that is not wavelength dependent in combination with optics, such as spectral filters, that are wavelength dependent. Such sensing apparatus may also be an array camera, with upstream of the sensing elements of the array camera different spectral filters, wherein two or more sensing elements are (relatively more) selective for different wavelengths.

Hence, in specific embodiments the sensing apparatus may be configured to sense (wavelength dependent) spectral intensities, such as wavelength dependent spectral intensity distributions, of radiation received by the sensing apparatus as a function of time in the one or more time-of-flight sensing modes, to provide a sensing system signal.

The term “sensing system signal” refers to a signal of the sensing system, especially generated by the sensing system when sensing the radiation from the object.

Here below, some further specific embodiments are discussed.

As indicated above, different pulses may be provided in time, wherein the pulses may differ in optical properties. This may facilitate one or more of 3D mapping of the object, determining the stage of growing, determining the presence of a disease, determining the health of the plant, etc. etc. Alternatively or additionally, the angle of incidence of the radiation may be varied between the pulses. This may be done with variable optics and/or with a sensing apparatus and radiation generator that may be movable relative to each other. In embodiments, variable optics may include one or more of a movable mirror or controllable lens. Hence, in embodiments the generator may be configured to generate in one or more of the one or more time-of-flight sensing modes of operation a plurality of pulses of radiation wherein two or more pulses of radiation differ in one or more of (a) optical properties, and (b) angle of incidence of the radiation. As also indicated above, in specific embodiments two or more pulses of radiation may differ in one or more of (i) polarization, and (ii) spectral intensity distribution (of the radiation). For instance, two or more, such as three or more, like five or, like e.g. ten or more pulses may be provided which differ at least 5 nm in peak wavelength, even more especially at least 10 nm in peak wavelength.

In specific embodiments, the radiation generator may comprise two or more lasers configured to generate radiation having different spectral intensity distributions, respectively. Further, especially in embodiments the generator may be configured to generate in one or more of the one or more time-of-flight sensing modes of operation a plurality of (consecutive) pulses of radiation with the two or more lasers. As indicated above, this may especially be combined with a sensing apparatus that may be configured to sense the different wavelengths that are generated by the radiation generator. For instance, pulses with different spectral intensity distributions (such as with different peak wavelengths) may respectively be generated during the respective consecutive pulses). Alternatively or additionally, pulses with different polarizations may respectively be generated (during the respective consecutive pulses).

In specific embodiments, a LIDAR may be applied. The LIDAR may provide a surveying method that measures distance to a target by illuminating the target with laser light and measuring the reflected light with a sensor. In specific embodiments, a laser-based time-of-flight camera may be applied. In such embodiments, the entire scene or spectral intensity distribution may be captured with each laser pulse.

For instance, according to OsramOptoSemiconductors Application Note AN106, for Lidar, two different main systems may be used to get a 3D point cloud, i.e. 3D Flash and Scanning Lidar. With a 3D Flash Lidar the pulsed laser beam is emitted to the whole solid angle of interest at one shot. To obtain a certain resolution of the point cloud, an n×m array of the photosensitive detector (e.g. arrays of photodiodes or CMOS ToF chip) is required. A scanning Lidar system may consist of a focused pulsed laser beam which is directed to a certain small solid angle by either a mechanical rotating mirror or a MEMS (micro electro-mechanical system) mirror. As the high power pulsed laser beam is controlled so as to be only emitted into a small solid angle, the reachable distance with the optical power used can be much larger compared to 3D Flash systems. Usually the mirrors used (mechanically rotating or MEMS) allow scanning in only one direction. The resolution in this direction is achieved with the pulse repetition frequency of the laser and the scanning frequency of the mirror. To obtain a certain resolution in the other direction, n×1 arrays of fast PiN photodiodes or avalanche photodiodes may be used.

In specific embodiments, the radiation generator may comprise a multispectral illumination source in combination with a processing component. The multispectral illumination source produces light having a plurality of wavelengths that illuminates a subject. In one embodiment, the multispectral illumination source includes a plurality of LEDs, wherein a first LED in the plurality of LEDs is capable of emitting light having a first wavelength and a second LED in the plurality of LEDs is capable of emitting light having a second wavelength, wherein the first and second wavelength are different. In another embodiment, the multispectral illumination source is a single element multi-color LED. Additionally, the light produced can be in the form of light pulses, modulated light, or both. The processing component measures the time the light has taken to travel from the multispectral illumination source to the subject and from the subject to the processing component. It also has the capability to calculate range information to localize the subject and to calculate a parameter of the derived from the light received from the subject. In this embodiment, the system may include at least one image sensor to sample the radiation received from the subject and electronic circuitry to control the operation of the multispectral illumination source. In embodiments of the present invention, the apparatus above may further comprise a spectral band-pass filter in the optical path of the processing component to suppress wavelengths not emitted by the multispectral illumination source. This may reduce the ambient light levels and result in better signal-to-noise (SNR) ratio and operability. In embodiments of the present invention, the apparatus above further comprises at least one image sensor to sense the light received from the subject and electronic circuitry to control the operation of the multispectral illumination source. In embodiments of the present invention, the apparatus above may further comprise a plurality of spectral band-pass filters located in proximity to the at least one image sensor, thereby filtering the light received from the subject on a pixel-by-pixel basis. Additionally, the multispectral illumination source can produce light having an illumination spectrum tuned to the plurality of spectral band-pass filters. This may increase the system's ability to filter light thus improving the energy efficiency and robustness of the system. In embodiments of the present invention, the multispectral illumination source can produce light including a subset of wavelengths wherein each of the wavelengths in the subset has a different modulation frequencies and the processing component configured to filter the wavelengths on a pixel-by-pixel basis based on the different modulation frequencies of the plurality of wavelengths.

Further, it appears that specific wavelengths may especially be useful, as they appear to offer larger signal to noise ratios. Especially one or more of the following wavelength ranges may be useful: 200-300 nm, 680-720 nm, 920-960 nm, 1080-1120 nm, 1340-1420 nm, and 1850-1890 nm. Therefore, in specific embodiments the radiation generator is configured to generate radiation in one or more of the one or more time-of-flight sensing modes of operation having a wavelength selected from the wavelength ranges of 200-300 nm, 680-720 nm, 920-960 nm, 1080-1120 nm, 1340-1420 nm, and 1850-1890 nm. In specific embodiments, the radiation generator may be configured to generate radiation having one or more wavelengths in the wavelength range of 200-300 nm. In such embodiments, e.g. a UV LED or UV laser, like a UV laser diode, may be applied. Such light source may have a relatively fast decay time, which is useful for ToF applications. Alternatively or additionally, the radiation generator may be configured to generate radiation having one or more wavelengths in at least two of the afore-mentioned wavelength ranges. The radiation(s) having these one or more wavelengths in one or more of these wavelength ranges may be provided simultaneously or sequentially (see also above). Especially, the radiation generator may be configured to generate one or more wavelengths in at least one or more of the following wavelength ranges of green and NIR. Alternatively, the radiation generator may be configured to generate one or more wavelengths in at least one or more of the following wavelength ranges of blue, green and red.

In the context of horticulture lighting, near-UV is defined as one or more wavelengths selected from the spectral range of 300-400 nm, blue is defined as one or more wavelengths selected from the spectral range of 400-500 nm, white is defined is defined as wavelengths selected from the spectral range of 400-700 nm (which selected wavelengths together may constitute white light, such as a combination of wavelengths in the blue and green and red), green is defined as one or more wavelengths selected from the spectral range of 500-600 nm, red is defined as one or more wavelengths selected from the spectral range of 600-700 nm, deep-red is defined as one or more wavelengths selected from the spectral range of 640-700 nm, and far-red is defined as one or more wavelengths selected from the spectral range of 700-800 nm. Deep-red is thus a sub selection of red. NIR is defined as one or more wavelength selected from the spectral range of 800-2500 nm, such as especially selected from the range of 800-2000 nm, like e.g. up to about 1200 nm. For instance, green may be more easily reflected and NIR may more easily penetrate in the plant object (part). Further, blue and/or red may e.g. be absorbed by chlorophyll (or “chlorophyl”).

To facilitate sensing, the sensing system may allow use of user input information. For instance, a user may indicate one or more of the type of plant, different plant parts, the stage of growing, the presence of a disease, the health of the plant, (and optionally also a type of 3D conformation), etc. On the basis thereon, the sensing system may optimize one or more of the optical properties and the angle of incidence. For instance, transparence of leaves may be taken into account, color of fruits or flowers may be taken into account, the 3D conformation may be taken into account, etc. This may be done preliminary to a (final) time-of-flight sensing mode. User input information may be provided via a user interface. Examples of user interface devices include a manually actuated button, a display, a touch screen, a keypad, a voice activated input device, an audio output, an indicator (e.g., lights), a switch, a knob, a modem, and a networking card, among others. Especially, the user interface device may be configured to allow a user instructing the device or apparatus or system, with which the user interface is functionally coupled or by with the user interface is functionally comprised. The user interface may especially include a manually actuated button, a touch screen, a keypad, a voice activated input device, a switch, a knob, etc., and/or optionally a modem, and a networking card, etc. The user interface may comprise a graphical user interface. The term “user interface” may also refer to a remote user interface, such as a remote control. A remote control may be a separate dedicate device. However, a remote control may also be a device with an App configured to (at least) control the system or device or apparatus. A user interface is especially functionally coupled to a control system or may be comprised by a control system.

Alternatively or additionally, the sensing system may include a further sensor, like a (simple) camera, that may be used for a (preliminary) detection of the 3D conformation of a plant, the type of plant, different plant parts, the stage of growing, the presence of a disease, the health of the plant, etc. On the basis thereon, the sensing system may optimize one or more of the optical properties and the angle of incidence. For instance, transparence of leaves may be taken into account, color of fruits or flowers may be taken into account, the 3D conformation may be taken into account, etc. This may be done during an initial mode of operation. The further sensor may e.g. be a tag reader.

The sensing system may sense in an iterative way. For instance, the control system may, based on the sensed radiation, evaluate one or more of the 3D conformation of a plant, the type of plant, different plant parts, the stage of growing, the presence of a disease, the health of the plant, etc. Based thereon, optical properties like e.g. one or more of wavelength, intensity, and polarization, but alternatively or additionally the angle of incidence (see also above) may be adapted on the basis of this evaluation and expected sensed radiation when the evaluation is correct. In this way, via an iterative process the optical properties and/or angle of incidence may be optimized to obtain a sensing system signal that may be reliable and/or have a low signal to noise ratio. For instance, transparence of leaves may be taken into account, color of fruits or flowers may be taken into account, the 3D conformation may be taken into account, etc. This may be done during an initial mode of operation, which may also be indicated as “preliminary time-of-flight sensing mode of operation”.

Hence, the control system may in embodiments use a feed forward loop and/or a feedback loop. Further, in embodiments multiple optimization cycles may be applied, for instance to optimize e.g. the S/R ratio, sensitivity, etc.

Therefore, in specific embodiments the sensing system may include one or more controllable sensing parameters, wherein the sensing system has an initial mode of operation wherein a value of the one or more controllable sensing parameters are defined in dependence of one or more of (i) user input information, (ii) a sensor signal of a sensor (such as a (simple)(digital) camera), and (iii) radiation received in a preliminary time-of-flight sensing mode of operation (of the sensing system), and wherein the sensing system is configured to execute one or more of one or more time-of-flight sensing modes of operation with the defined sensing parameters after executing the initial (or preliminary) mode of operation.

As can also be derived from the above, especially the controllable sensing parameters may be selected from the group consisting of (i) polarization of the radiation, (ii) spectral intensity distribution of the radiation, (iii) angle of incidence of the radiation, (iv) pulse modulation and/or pulse frequency, and (v) polarization filter upstream of a detector of the sensing apparatus.

As indicated above, in embodiments the polarization of the radiation provided by the radiation generator may differ over time and/or differ over spatial position over an emission window of the radiation generator. Alternatively or additionally, the polarization of the radiation sensed by the sensing apparatus may be differ over time and/or differ over spatial position over an entrance window of the sensing apparatus.

For instance, during interactions inside the tissue of the plant the propagation direction of the radiation (and later emitted radiation) might change, and may e.g. become multi-directional, etc. Also the polarization may be changed. With the invention, also retention time inside the plant tissues may be taken into account and may provide information. Likewise, with the invention, also (biological) components inside the plant (tissue) may be taken into account. Such information may also be derived from the sensed radiation.

In specific embodiments, the control system may be configured to determine from the initial mode of operation at least two different types of radiation wherein a first type of radiation has a larger penetration depth in an (plant) object being sensed than a second type of radiation, and to execute the one or more of one or more time-of-flight sensing modes of operation with the at least two different types of radiation. Alternatively or additionally, the control system may be configured to determine from the initial mode of operation at least two different types of radiation wherein for a first type of radiation the (plant) object has a larger absorption than for a second type of radiation, and to execute the one or more of one or more time-of-flight sensing modes of operation with the at least two different types of radiation. Alternatively or additionally, the control system may be configured to determine from the initial mode of operation at least two different types of radiation wherein upon a first type of radiation the (plant) object provides a stronger luminescence than for a second type of radiation, and to execute the one or more of one or more time-of-flight sensing modes of operation with the at least two different types of radiation. In specific embodiments, the control system may be configured to determine from the initial mode of operation at least two different types of radiation wherein a first type of radiation has a larger penetration depth in a first part of an (plant) object being sensed than a second type of radiation, and to execute the one or more of one or more time-of-flight sensing modes of operation with the at least two different types of radiation. Alternatively or additionally, the control system may be configured to determine from the initial mode of operation at least two different types of radiation wherein for a first type of radiation a first part the (plant) object has a larger absorption than for a second type of radiation, and to execute the one or more of one or more time-of-flight sensing modes of operation with the at least two different types of radiation. Alternatively or additionally, the control system may be configured to determine from the initial mode of operation at least two different types of radiation wherein upon a first type of radiation a first part the (plant) object provides a stronger luminescence than for a second type of radiation, and to execute the one or more of one or more time-of-flight sensing modes of operation with the at least two different types of radiation. The terms “first type of radiation” and “second type of radiation” may in embodiments especially refer to radiations having different spectral power distributions, such as different colors. Alternatively, these terms may refer to radiations having (essentially) the same spectral power distributions, but having different polarization. In yet further embodiments, terms “first type of radiation” and “second type of radiation” may in embodiments especially refer to radiations having different spectral power distributions, such as different colors, which may optionally also have different polarizations. Note that lasers having different wavelengths have by definition different spectral power distributions.

In specific embodiments, the control system may be configured to determine from the initial mode of operation at least two different types of radiation wherein (a) for a first type of radiation apply one or more of (i) having a larger penetration depth in a first part of an (plant) object being sensed than a second type of radiation, (ii) being absorbed stronger in the first part of an (plant) object being sensed than a second type of radiation, and (iii) generating a stronger luminescence from the first part of an (plant) object being sensed than a second type of radiation, and (b) for a second type of radiation apply one or more of (i) having a larger penetration depth in a second part of an (plant) object being sensed than the first type of radiation, (ii) being absorbed stronger in the second part of an (plant) object being sensed than the first type of radiation, and (iii) generating a stronger luminescence from the second part of an (plant) object being sensed than the first type of radiation, wherein the first part of the plant and the second part of the plant differ; and to execute the one or more of one or more time-of-flight sensing modes of operation with the at least two different types of radiation. The first plant part and second plant part may e.g. be selected from the group consisting of flowers, flower parts, leaves, stems, branches, aerial roots, etc. etc. Flower parts may e.g. be selected from the group consisting of petals, stigma, anther, style, ovule, filament, and sepal (and optionally peduncle).

In specific embodiments, it may be desirable to sense offset from an irradiation position. This may be used, for instance, to measure propagation lengths, differences in transmission for different wavelengths, etc. Hence, in embodiments the radiation has a beam cross-section (A1), wherein the sensing apparatus has a field of view cross-section (A2) (in one or more of the one or more time-of-flight sensing modes of operation), wherein the radiation generator and the sensing apparatus have a predetermined configuration wherein within a predetermined distance (d2) from an entrance window of the sensing apparatus the beam cross-section (A1) and the field of view cross-section (A2) do not overlap, wherein the predetermined distance (d2) is selected from the range of 0-500 cm. In yet other configurations, wherein e.g. the sensing apparatus and radiation generator are not comprised in a single device, but may be configured movable to each other, the predetermined distance may in embodiments be larger. Therefore, in e.g. alternative examples, or applications, a predetermined distance selected from the range between 500 cm and 1500 cm may be envisioned. For indoor applications, such as a horticulture plant, the predetermined distance (d2) selected from the range of 0-500 cm may suffice, though other embodiments may also be possible. For instance, for outdoor applications the predetermined distance (d2) may be selected from the range of 0-500 cm but may in alternative embodiments selected at larger distances.

Of course, the predetermined distance may be longer or smaller, when the condition of non-overlap is not relevant. Further, in specific embodiments radiation may be sensed via one or more optics in common. For instance, a dichroic mirror may be used in the pathway of the radiation of the radiation generator and the same dichroic mirror may be used in the pathway of luminescence to the sensing apparatus.

The sensing system signal may be useful as such, for instance to get a better status overview of the object(s). However, the sensing system signal may also be used to control (another) device (or apparatus or system). Hence, as mentioned before, the sensing system functionally coupled to an agricultural device, wherein the agricultural device is controllable in dependence of the sensing system signal. The functional coupling of the sensing system and the agricultural device may be wireless and/or via wires. Especially, the functional coupling of the sensing system and the agricultural device may include that the control system of the sensing system controls the agricultural device and/or that a(nother) control system controls the agricultural device in dependence of the sensing system signal. The agricultural device may comprise one or more devices selected from the group consisting of a nutrient providing device, an irrigation device, a pruning device, a weeding device, a harvesting device, a temperature control device, a humidity control device, a horticulture radiation control device, a curing device, etc. etc. A curing device may be configured to provide one or more of a pesticide, an herbicide, a fungicide, etc. Hence, the sensing system signal may be used to control an actuator of another device, such as an agricultural device, in dependence of such sensing system signal.

The conditions to which the (growing) plants are subjected are in general defined in a recipe. Hence, the control system may grow the plants according to a recipe. Such recipe may include a light recipe, which defines a predetermined horticulture light intensity. This may imply that the recipe defines a predetermined horticulture light intensity over time. Alternatively or additionally, the recipe may define a predetermined horticulture light intensity as function of parameters that are sensed, like intake of nutrients, leaf size, plant temperature, leave temperature, root temperature, stem length, fruit size, etc. etc. Other parameters may also be sensed, such as one or more of temperature (in the greenhouse, farm, climate cell, tunnel, etc.), humidity, gas composition. Also the daylight intensity (would also solar light be applied) may be a parameter to be sensed. A recipe directed to lighting parameters may be indicated as “light recipe”. A light recipe may be comprised by a recipe that also include other parameters, such as one or more of leave temperature, root temperature, ambient temperature, etc.

Here, the term “horticulture light” is used for artificial light that is used to irradiate the plant objects during at least part of the day. The spectral power distribution of the horticulture light may vary over the day and/or during the entire growth period.

In yet a further aspect, the invention also provides an agricultural facility comprising the sensing system as defined herein. The agricultural facility may comprise a control system which is the control system of the sensing system or which may be functionally coupled to the control system of the sensing system.

The agricultural facility may in embodiments especially be selected from the group of a greenhouse and a horticulture arrangement. A horticulture arrangement may in embodiments include a vertical farming plant. Further, the agricultural facility may in embodiments especially be selected from the group of an open field, a yard (such as a vineyard), a plantation, etc. Instead of the term “horticulture arrangement” also the term “horticulture plant”; in such embodiments the term “horticulture plant” refers to building or other construction (not to the biological plant). Especially, the term “horticulture arrangement” refers to a plant factory or climate cell, wherein the plants are grown under controlled conditions, and wherein the plants substantially do not receive natural day light. Further, such plant factory may be climatized, such as in the case of a climate cell. Hence, in embodiments the horticulture arrangement includes such plant factory or climate cell. Herein, the term plant factory is considered to encompass the embodiment of a climate cell.

Typically, in a plant farm, plants are grown in climate cells. Each cell is equipped with one or more racks. Each rack has multiple layers for growing plants.

In specific embodiments (as also indicated above), the invention provides an agricultural facility comprising the sensing system as defined herein, wherein one or more of the radiation generator and the sensing apparatus are configured movable, and wherein the control system may especially be configured to control one or more of (i) a position of the radiation generator and (ii) a position of the sensing apparatus. For instance, in embodiments one or both of the radiation generator and the sensing apparatus may be translatable along a rail. In specific embodiments, one or more of the radiation generator and the sensing apparatus may be comprised by (different) drone(s). Hence, in yet further specific embodiments both the radiation generator and the sensing apparatus may be configured movable relative to each other (such as via rails and/or drones).

As can be derived from the above, in specific embodiments the control system (of the sensing system or agricultural facility) may be configured to execute an action in dependence of the sensing system signal. In specific embodiments, the action may be selected from the group consisting of controlling growing conditions of a plant, controlling irradiation (with e.g. one or more of UV, visible and IR radiation) of a plant or plant part, controlling harvesting of a plant or a plant part, controlling treatment of a plant, and controlling pruning of a plant. Further, in specific embodiments the agricultural facility may be selected from the group consisting a horticulture arrangement, a greenhouse, and an open field. Here, controlling irradiation refers to the irradiation to the plant for controlling growth, etc.

In use, the agricultural facility may include a plant support with a plant, or a plant support with a seed, or a plant support with a seedling, etc. Hence, in use the agricultural facility may include a plant support with a plant, or a plant support with a seed, or a plant support with a seedling, etc. The terms “support” or “plant support” may refer to one or more of (particulate) substrate, aqueous substrate (in hydroponics), soil, wire (for wire crops), etc., which can be used to grow plants in, on, or along, etc.

The control system of such agricultural facility may control one or more of temperature, humidity, irrigation, nutrient supply, light intensity of the horticulture light, air conditions including one or more of air temperature, air composition, air flow, etc. Such horticulture system may be configured to control one or more of these conditions at different locations in the arrangement.

In yet a further aspect, the invention provides a monitor (and optional control) method, especially a plant monitor (and optional control) method, comprising executing a time-of-flight sensing mode of operation, wherein the method comprises subjecting one or more plants to a pulse of radiation, sensing radiation received by a sensing apparatus as function of time in the time-of-flight sensing mode of operation, and generating a sensing system signal. Especially, the method may comprise executing the time-of-flight sensing mode of operation with the sensing system as defined herein. In specific embodiments, during the time-of-flight sensing mode different types of radiation may be provided, which may differ in one or more of (peak) wavelength, spectral intensity distribution, and polarization (see also above).

In yet further specific embodiments, the plant monitor method may further comprise executing an action in dependence of the sensing system signal. In specific embodiments, the action is selected from the group consisting of controlling growing conditions, controlling harvesting, controlling treatment, and controlling pruning.

Instead of the phrase “plant monitor (and optional control) method”, and similar phrases, also the phrase “plant monitoring (and optional control) method” or “plant monitoring (and optional controlling) method”, and similar phrases, may be applied.

In yet a further aspect, the invention provides the use of time of flight spectroscopy in a plant monitor (and optional control) method. Further, in an aspect the invention provides the use of time of flight spectroscopy in horticulture application, e.g. for sensing one or more of the 3D conformation of a plant, the type of plant, different plant parts, the stage of growing, the presence of a disease, the health of the plant, depth and tissue information, etc.

Hence, in embodiments time of flight spectroscopy may be used in a monitor (and optional control) method, especially a plant monitor (and optional control) method. In embodiments, time of flight spectroscopy may be used for sensing and/or monitoring agricultural areas or other type of essentially natural outdoor areas, like wood, (tropical rain) forest, meadows, heather, steppe, savanna, parks, etc. In embodiments, time of flight spectroscopy may be used for sensing and/or monitoring agricultural areas or other type of essentially natural outdoor areas, like rivers, river deltas, lakes, seas, oceans, parks, etc.

In embodiments, the herein described sensing system may be used for monitoring (and optional controlling), especially plant monitoring (and optional controlling) In embodiments, the herein described sensing system may be used for sensing and/or monitoring agricultural areas or other type of essentially natural outdoor areas, like wood, (tropical rain) forest, meadows, heather, steppe, savanna, parks, etc. In embodiments, the herein described sensing system may be used for sensing and/or monitoring agricultural areas or other type of essentially natural outdoor areas, like rivers, river deltas, lakes, seas, oceans, parks, etc.

In yet a further aspect, the invention also provides a software product (or (other) computer program product) when running on a computer is capable of bringing about the plant monitor (and optional control) method as described herein. Such computer may comprise the herein described control system, or may be the herein described control system. Hence, such computer may in embodiments be comprised or functionally coupled to the herein described sensing system or agricultural facility.

Therefore, the invention further also provides a computer program product enabled to carry out the method as defined herein, for instance when loaded on a computer (that is functionally coupled to the agricultural facility). In yet a further aspect, the invention provides a record carrier (or data carrier, such as a USB stick, a CD, DVD, etc.) storing a computer program (for executing the herein described method). Hence, the computer program product, when running on a computer or loaded into a computer, brings about, or is capable of bringing about, the method as described herein. Therefore, in a further aspect the invention provides a computer program product, when running on a computer which is functionally coupled to or comprised by the agricultural facility, especially as defined herein, is capable of bringing about the method as described herein.

The record carrier or computer readable medium and/or memory may be any recordable medium (e.g., RAM, ROM, removable memory, CD-ROM, hard drives, DVD, floppy disks or memory cards) or may be a transmission medium (e.g., a network comprising fiber-optics, the world-wide web, cables, and/or a wireless channel using, for example, time-division multiple access, code-division multiple access, or other wireless communication systems). Any medium known or developed that can store information suitable for use with a computer system may be used as the computer-readable medium and/or memory. Additional memories may also be used. The memory may be a long-term, short-term, or a combination of long- and-short term memories. The term memory may also refer to memories. The memory may configure the processor/controller to implement the methods, operational acts, and functions disclosed herein. The memory may be distributed or local and the processor, where additional processors may be provided, may be distributed or singular. The memory may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network, such as the Internet, is still within memory, for instance, because the processor may retrieve the information from the network.

In an aspect, the invention also provides a system comprising the sensing system as described herein.

In aspects, the invention provides a light generating system, comprising one or more light sources (especially for generating visible light), and the sensing system as described herein. Moreover, in such embodiments, the control device of the sensing system may be configured to control the one or more light sources to illuminate a plant with a lighting characteristic. Hence, in a paragraph, the invention provides: A light generating system comprising one or more light sources and a sensing system, the sensing system comprising a radiation generator, a sensing apparatus, and a control system functionally coupled to the radiation generator and the sensing apparatus, wherein the sensing system has one or more time-of-flight sensing modes of operation, wherein the generator is configured to generate a pulse of radiation in the one or more time-of-flight sensing modes of operation, and wherein the sensing apparatus is configured to sense wavelength dependent spectral intensities of radiation received by the sensing apparatus as a function of time in the one or more time-of-flight sensing modes, to provide a sensing system signal; wherein the control device of the sensing system may be configured to control the one or more light sources to illuminate a plant with a lighting characteristic. Said lighting characteristic may e.g. be a light recipe, a light color, a light intensity, a light modulation, a color temperature, a light pattern, or light scene. The light generating system may be arranged in an agricultural facility. The light generating system may be a luminaire or a light fixture. The advantages and/or embodiments applying to the sensing system according to the invention may therefore apply mutatis mutandis to the light generating system according to the invention.

In yet further specific embodiments, the invention provides a light generating device comprising (the light generating system comprising the) one or more light sources, and the sensing system as described herein. Hence, such system (or device) may comprise one or more light sources, especially for generating visible light and the radiation generator.

In aspects, the sensing system according to the invention may be applied mutatis mutandis in aquaculture applications.

In aspects, the invention provides an agricultural robot comprising the sensing system according to the invention. Moreover, said agricultural robot may comprise an agricultural device according to the invention, such as a picking arm, and/or a lighting device, etc.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1b schematically depict some embodiments of a sensing system;

FIGS. 2a-2b schematically depict some aspects;

FIGS. 3a-3b schematically depict some embodiments; and

FIGS. 4a-4e schematically depict various further aspects.

The schematic drawings are not necessarily to scale.

### DETAILED DESCRIPTION OF THE EMBODIMENTS

Possible robotized solutions for inspection and/or handling of plants and fruits may need to be able to correctly detect the plants/fruits. Amongst others, herein an (optimized) time-of-flight solution using active illumination with wavelengths which may be optimal for horticultural applications is proposed. By applying a wavelength tailored to the reflective/absorbing/luminescent properties of the plant or fruit, the accuracy and robustness of the range information may be improved. When applying two or more wavelengths, the difference in reflection of each wavelength can be used to classify the plant part or assess the condition and health of the plant (e.g. dehydration level or presence of diseases). It can be used for evaluation of the fruit status (e.g. ripeness, presence or concentration of certain components) to guarantee the quality of the fruit and automatically determine the best moment of harvesting. Also, a wavelength can be chosen such that it will penetrate through for example leaves and is reflected by a fruit. This enables the detection of fruits even in case of occlusion by leaves. Using an additional wavelength reflected by leaves will provide information how to approach the fruit with a robotized gripper. The provided functionality like seeing through leaves and multi-spectral analysis of plant/fruits is a very difficult, subjective and probably impossible task for (unskilled) workers.

Amongst others, active illumination for SNR improvement of range measurement may be provided. For instance, an active illumination with a wavelength which may be optimally reflected by the fruit/plant to be inspected may be used. For example, the reflectance of tomatoes appears to differ from leaves in the visible range but also in the SWIR range (1000-1900 nm). For instance, active illumination at 930 nm appears to be poorly reflected by tomatoes resulting in a lower SNR of the range signal, whereas for example using a 750 nm wavelength the SNR may be much better. Also, indirect light reflections scattering could have a negative effect on the range measurement. In case we are interested in range information of only tomatoes, a wavelength around the chlorophyll absorption spectrum of leaves and a relatively high reflectance for tomatoes can be selected (like e.g. 625 nm). The wavelengths could also be chosen such that the impact (disturbance) of sun light is reduced (see right picture for the spectrum).

The absorption spectra of tomatoes and tomato leaves are partially overlapping and therefore a single wavelength can be used to measure the range. However, it may also be useful to use different wavelength, wherein at least one wavelength is selected from a wavelength range wherein there is small or no overlap. In case of fruits and flowers with low reflectance in the overlapping part of the spectrum of leaves (e.g. blue flowers in the example below) the active wavelength used could be chosen between 450-500 nm.

Further, amongst others monochromatic/multi-spectral active illumination for spectral measurement with range and shape compensation. In further embodiments, active illumination may be used where the intensity of the active illumination may be optimized for the range/geometry and optical characteristics of the fruit/plant to be inspected. The reflection/absorption/transmission of the active illumination may depend on the distance to the plant, the orientation of the surface orientation for different wave lengths. The active illumination may use the information to adapt the intensity of the active (multi-spectral) illumination source to improve the signal quality.

Yet further, amongst others multi-spectral active illumination for seeing through leaves may be applied. When observing both fruits and leaves, their difference in spectral response can be exploited to see through leaves. For instance, such wavelength that (partially) penetrates through vegetation and reflects on fruits may be used, while measuring the distance. By having an additional wavelength reflected by leaves, an automated solution can use the measured 3D properties of both the fruits and leaves to automate the picking of fruits.

In embodiments, multi-spectral active illumination for plant growth and health monitoring may be applied. For instance, when using two or more specific wavelengths, the growth or health status of plants can be retrieved by taking the ratio of the spectral responses. For instance, the maturity of a flower or of a fruit may be determined by monitoring the reflectance within an entire first spectral range as reference while using the reflectance at a subset of wavelengths within (or even outside) such first range. Similarly, diseases can be detected from comparison of multiple responses.

Further, in embodiments multi-spectral active illumination for penetration measurement may be applied. The penetration of light in plants may depend on the wavelength used. Long wavelength red or near infrared (NIR) light may penetrate deeper in the leaf compared with blue light, which may be due to higher scattering on cell membranes and cell-to-cell interfaces. The measured distance for the different spectral components can be used to determine the penetration depth of the different wavelengths.

In embodiments, multi-spectral active illumination for fluorescence measurement may be applied. For instance, fluorescence reabsorption within a leaf may depend on the luminescence wavelength. Red fluorescence may have a larger probability of (at least partially) being reabsorbed by chlorophyll within the leaf compared with far-red fluorescence, due to the characteristics of the chlorophyll absorption spectra. Likewise, when a broad band radiation in the red is provided, this may have a larger probability of (at least partially) being reabsorbed by chlorophyll within the leaf compared with a broad band radiation in the far-red. The active illumination can be both used for range sensing and fluorescence measurement.

Yet further, in embodiments multi-spectral active illumination for scatter and BRDF measurement may be provided. For instance, 3D information may be used to reconstruct the surface and thus incident angle of the active light to measure the characteristics of the light reflected. The light scatter or the bidirectional reflectance distribution function (BRDF) can be used for monitoring plant development/health. The scatter effects could depend on the wavelength used.

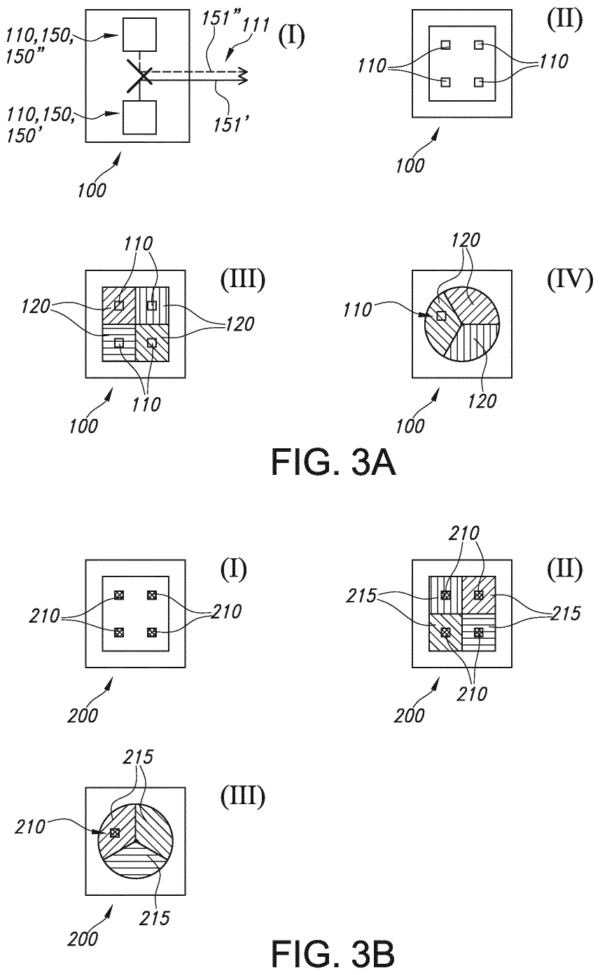

In embodiments, multi-spectral active illumination for polarization measurement may be applied. For instance, a time-of-flight sensor with elements with different polarizations (see FIG. 3B) and non-polarized radiation may be applied. The effect of the plant on the polarization can be used for monitoring plant development (e.g. presence of cannabis flowers or ripening level of cannabis flowers based on e.g. detection and monitoring of amount and size of trichomes or terpene compounds in the trichomes). Another option is to use polarized light sources with sensing elements with(out) different polarization. However, also a combination of polarized radiation and a sensing apparatus which can measure different polarizations may be applied.

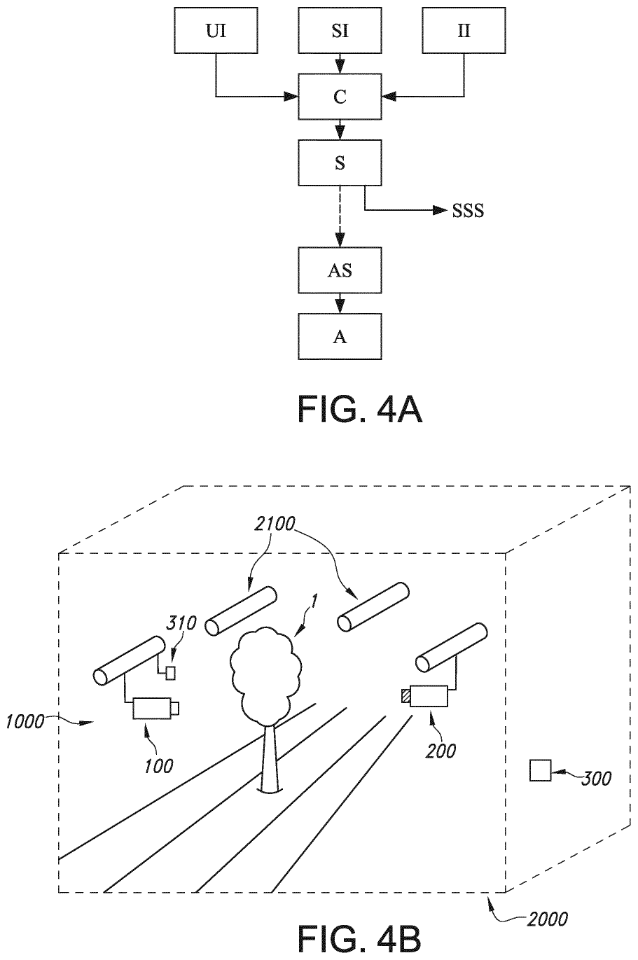

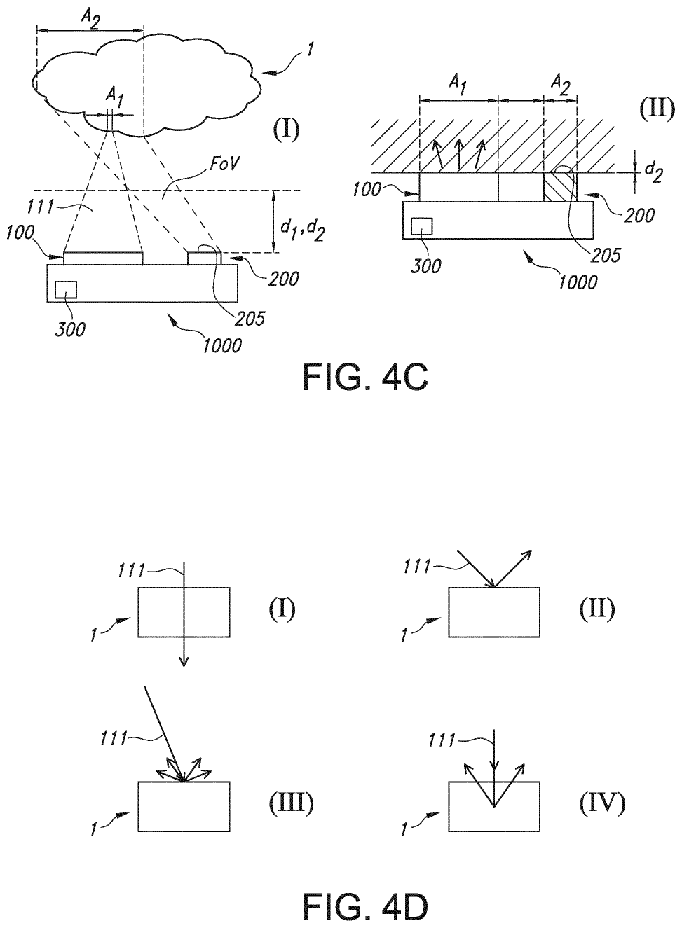

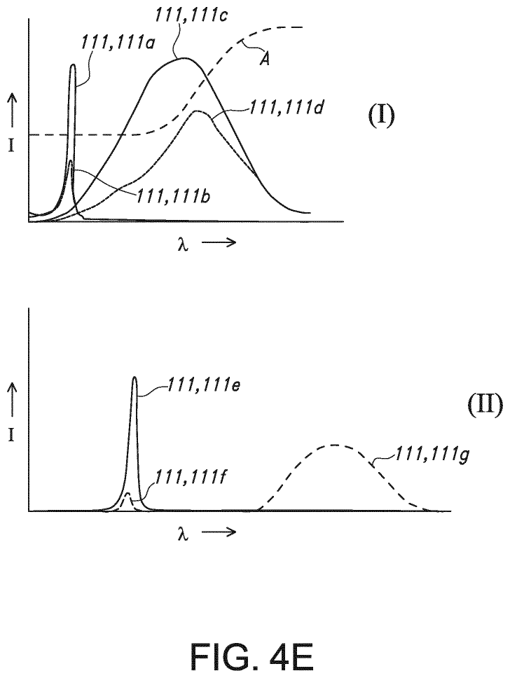

In yet further embodiments, multi-spectral active illumination for internal propagation/scatter measurement may be applied. For instance, the time-of-flight signal may be used to measure the propagation of light within the plant. By partially illuminating the plant with the active illumination the non-illuminated areas can be used as measurement location. One can measure the time for the light to enter the plant, propagate trough the plant (parts), and is next received by the sensor (see FIG. 4c (variant II)). The direct return reflection is measured by the sensing elements observing the areas illuminated by the active illumination, while the indirect reflection (that includes propagation through the plant) is measured via the sensing elements observing non-illuminated parts (see FIG. 4c (variant II)). The propagation of light through the plant also depends on the wavelength, providing additional information Also propagation time depends on internal-plant scatter effects, providing e.g. information of type and number of scatter locations (e.g. cell types, -size and -numbers, osmotic pressure in the cells, hydration level of the tissue, etc.).

With the aid of monochromatic and/or polychromatic active illumination range information can be extracted, which can be used to adapt/calibrate the spectral information. With the aid of monochromatic and/or polychromatic active illumination shape (3D conformation) information can be extracted, which can be used to adapt/calibrate the spectral information.

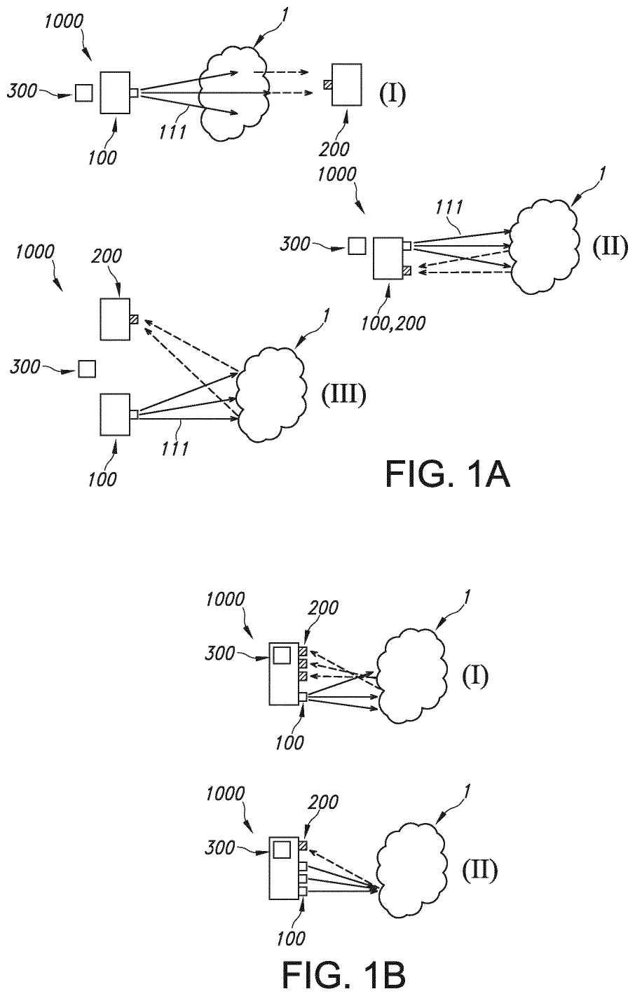

FIGS. 1a-1b schematically depict some embodiments of a sensing system 1000, such as here for agricultural application. Reference 1 refers to a very schematically depicted plant object, such as a plant, a tree, a bush, etc.

The sensing system comprises a radiation generator 100, a sensing apparatus 200 (functionally coupled to the generator 100), and a control system 300 functionally coupled to the radiation generator 100 and the sensing apparatus 200. Two or more of the radiation generator 100, sensing apparatus 200, and a control system 300 may be integrated in a single device. However, they may also be comprised in two or more different devices, see embodiments I and III, which show three separate devices, and embodiment II wherein the radiation generator 100 and sensing apparatus 200 are included in a single apparatus.

In embodiments, the radiation generator 100 may be configured to generate in one or more of the one or more time-of-flight sensing modes of operation a plurality of pulses of radiation 111, wherein in specific embodiments two or more pulses of radiation 111 differ in one or more of (a) optical properties, and (b) angle of incidence of the radiation 111 (see further also below).

The sensing system 1000 has one or more time-of-flight sensing modes of operation, wherein the generator 100 is configured to generate a pulse of radiation 111 in the one or more time-of-flight sensing modes of operation, and wherein the sensing apparatus 200 is configured to sense (wavelength dependent) spectral intensities, such as wavelength dependent spectral intensity distributions, of radiation received by the sensing apparatus 200 as a function of time in the one or more time-of-flight sensing modes, to provide a sensing system signal.

FIG. 1b schematically depicts embodiment wherein radiation may be measured under different angles (variant I) or may be generated under different angles (variant II); the latter may result in different angles of incidence. Of course, the variants I and II may also be combined.

The returning radiation, which may be sensed by the sensing apparatus 200, may be reflected by the plant object 1, and/or may be reflected or scattered after being transmitted through at least part of the plant object 1, and/or may be luminescence from the plant object 1 due to irradiation with the radiation 111.

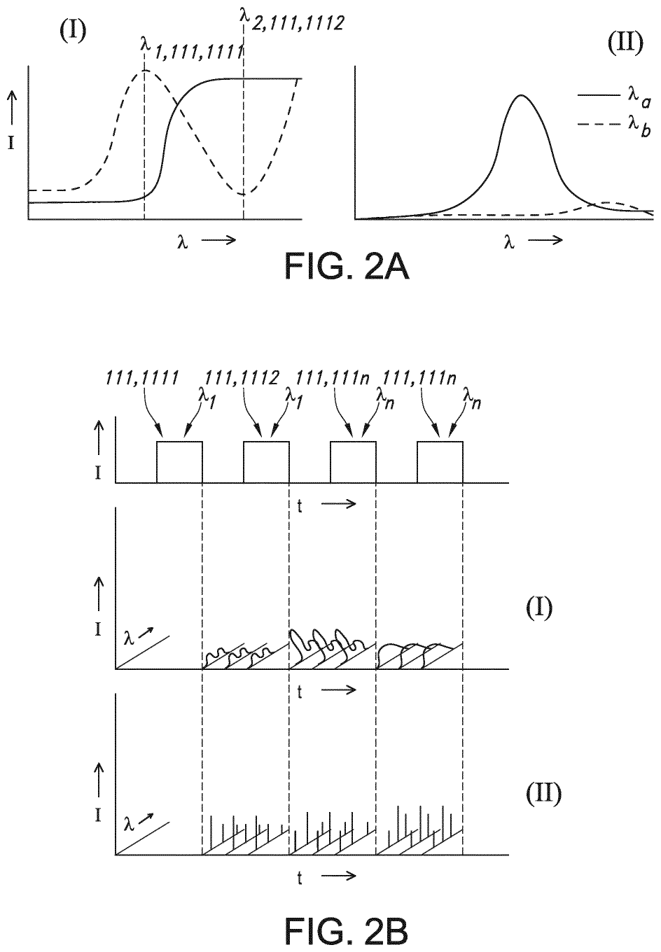

FIG. 2a, variant I, very schematically depict different transmissions (transmission curves) of two different plant parts, such as e.g. leaves and stem or leaves and fruit. Radiations 1111 and 1112 and λ₁ and λ₂ indicate wavelengths of radiation which will have different impacts on the different plant parts. The first wavelength λ₁ will be absorbed by a first plant part (solid curve) and essentially not by the second plant part (dashed curve); the second wavelength λ₁ will be absorbed by the second plant part (dashed curve) and may essentially not by absorbed by the first plant part (solid curve). Variant II very schematically depicts luminescence under radiation with different wavelengths. Irradiation with λₐ provides a clear luminescence band, whereas irradiation with λ_{b} there is essentially no luminescence (the weak luminescence observed is also shifted relative to the luminescence under λₐ irradiation). Note that there may also be plant parts that do essentially not luminesce at all.

FIG. 2b (top) schematically depicts a plurality of pulses of radiation 111. These pulses can all be the same.

Here, by way of example the pulses are essentially the same in pulse duration and distance between the pulses, but the pulses may differ in the spectral intensity distribution (and/or polarization). This is indicated with and λ₁, λ₂, and λₙ which may indicate one of the afore-mentioned, or even yet further wavelengths differing from λ₁ and λ₂. Alternatively or additionally, pulses may also differ in polarization.

Further, alternatively or additionally pulses may differ in one or more of pulse duration, pulse intensity (pulse height), pulse repetition rate, etc.

In general, the pulses are relatively short and have short rise and decay times in view of the ToF detection. Pulses as short as about 1.25 ns full width half maximum (FWHM) may well be possible.

After the pulse or after each pulse, the radiation from the object may be detected. As indicated above, this may include reflected radiation, transmitted radiation, scattered radiation, luminescence. This radiation may be detected as function of time after the pulse. This sensing may be done for one or more, especially a plurality, of radiation wavelengths, and especially at at least two different times after the pulse.

FIG. 2b (lower part) schematically depict two embodiments or variants, wherein after each pulse at three different times the radiation is measured. In variant I, a spectral intensity distribution over a wavelength range is sensed; in variant II at two or more different wavelengths, here by way of example three different wavelengths, the intensity is measured. The spectral intensities may vary over time (after the pulse) and may also mutually vary over time (after the pulse). From the spectral intensities, as well as over the time dependence thereof, one or more of 3D conformation of a plant, the type of plant, different plant parts, the stage of growing, the presence of a disease, the health of the plant, etc., may be determined. Hence, based on the sensing system signal, one or more of 3D conformation of a plant, the type of plant, different plant parts, the stage of growing, the presence of a disease, the health of the plant, etc., may be determined.

A plurality of pulses of two or more different radiations will in general be generated consecutively, with (at least) sensing time in between, as will be known to a person skilled in the art. Two or more pulses may e.g. differ in wavelength and/or polarization.

FIG. 3a schematically depict some embodiments of the radiation generator 100, wherein the radiation generator comprises at least two sources of radiation, indicated with reference 110.

Variant I schematically depicts a cross-sectional view of an embodiment of the radiation generator 100, where two different sources of radiation 110, here laser sources 150 of radiation, each generating radiation 151, but having different spectral intensity distributions, such as a blue and a red laser, respectively. The different radiations are indicated with references 151′ and 151″ With optics, the beams can be combined to provide a single beam. The radiation 111 escaping from the radiation generator 100 may be indicated with references 111′ and 111″, respectively. Note that these radiations 111′ and 111″ may essentially be the same as the radiations 151′ and 151″, as the optics used may be chosen to have essentially no impact on the spectral intensity distribution. Hence, in embodiments the radiation generator 100 may comprise two or more lasers 150 configured to generate radiation 111 having different spectral intensity distributions, respectively, and wherein the generator 100 is configured to generate in one or more of the one or more time-of-flight sensing modes of operation a plurality of pulses of radiation 111 with the two or more lasers 150 (consecutively).

Variant II very schematically depicts a front view of an embodiment of the radiation generator 100, here comprising four different sources of radiation 110. These may be configured to generate the radiation 111, but having different spectral intensity distributions.

Variant III in FIG. 3a schematically depicts a similar radiation generator 100 as variant II, but now with optical filters 120 downstream of the sources of radiation 110. The optical filters may be used to change the spectral intensity distribution of the respective radiations of the respective sources of radiation 110. Alternatively or additionally, the optical filters may be used to impose a polarization to the respective radiations of the respective sources of radiation 110.

The sources of radiation 110 may provide in a (ToF) controlling mode radiation 111 simultaneously, especially when the sensing system may also detect different spectral intensities, such as wavelength dependent spectral intensity distributions, and/or polarizations. In an alternative (ToF) controlling mode the sources of radiation 110 may provide radiation 111 sequentially.

In variant IV, the source of radiation 110 may be configured to provide radiation having different wavelengths, especially broad band radiation, though e.g. a white multi-LED light source of radiation may also be possible. Alternatively or additionally, the source of radiation 110 may be configured to provide radiation having different polarizations (or the radiation is unpolarized). Downstream of the source of radiation an optical wheel with a plurality of optical filters 120 may be configured. The optical filters may be used to select a subset of the wavelengths and/or impose a specific polarization to the radiation 111.

Note that with sources of radiation 110 which are configured at different positions relative to each other (see variants II and III), it may possible to generate a beam with different optical paths (unlike variant I and IV).

Hence, as indicated above in embodiments the generator 100 may be configured to generate in one or more of the one or more time-of-flight sensing modes of operation a plurality of pulses of radiation 111 wherein two or more pulses of radiation 111 differ in one or more of (a) optical properties, and (b) angle of incidence of the radiation 111, and wherein the optical properties are selected from the group consisting of i polarization, and ii spectral intensity distribution (of the radiation 111).

Similar variants as schematically depicted above in relation to the radiation generator 100 may also be relevant for the sensing apparatus 200 as shown in FIG. 3b.

Variant I schematically depicts an embodiment of the sensing apparatus 200 comprises a plurality, here four, of sensing devices 210. These sensing device 210 may be configured to sense the same type of radiation (but inherently under (slightly) different angles), or may be configured to sense different types of radiation, in terms of spectral intensity distributions and/or polarization.

Variant II schematically depicts an embodiment of the sensing apparatus 200 with a plurality, here four, of sensing devices 210 which may e.g. be able to sense over a plurality of wavelengths radiation and/or essentially independent of polarization. However, optical filters 215 may be used to selected specific wavelengths and/or specific polarizations. Especially, the optical filters 215 are thus configured upstream of the sensing devices 210.

In variant III, an embodiments of the sensing apparatus 200 is schematically depicted with e.g. a single sensing device 210 which may e.g. be able to sense over a plurality of wavelengths radiation and/or essentially independent of polarization. However, optical filters 215, comprised by a filter wheel, may be used to selected specific wavelengths and/or specific polarizations. Especially, the optical filters 215 are thus configured upstream of the sensing devices 210.

Note that in FIG. 3a, variants III and IV, the small squares 110 are behind the plane of drawing and in FIG. 3b, variants II and III, the (hatched) small squares 210 are behind the plane of drawing.

FIG. 4a schematically depicts some possible stages and variants of the sensing method. Reference UI indicates user input, reference SI indicates a sensor input, and II indicates input via an iteration process. Reference C indicates a computing stage, where on the bases of one or more of user input UI, sensor input SI, and the iteration input II, optimized sensing parameters may be chosen. Then, the sensing stage (S) may start or commence, leading to a sensing system signal SSS. The sensing system signal SSS as such may be used, to derive or obtain information about the 3D conformation of a plant, the type of plant, different plant parts, the stage of growing, the presence of a disease, the health of the plant, etc. The sensing system signal SSS may also be used as input (trigger) of another apparatus. Here, AS may refer to e.g. an agricultural system which may include an apparatus, especially for executing an agricultural action. For instance, the action may be selected from the group consisting of controlling growing conditions of a plant, controlling irradiation of a plant or plant part, controlling harvesting of a plant or a plant part, controlling treatment of a plant, and controlling pruning of a plant

Hence, in embodiments the sensing system 1000 may include one or more controllable sensing parameters, wherein the sensing system 1000 has an initial mode of operation wherein a value of the one or more controllable sensing parameters are defined in dependence of one or more of (i) user input information, (ii) a sensor signal of a sensor 310 (see also FIG. 4b), and iii radiation received in a preliminary time-of-flight sensing mode of operation (of the sensing system 1000), and wherein the sensing system 1000 is configured to execute one or more of one or more time-of-flight sensing modes of operation with the defined sensing parameters after executing the initial mode of operation.

As indicated above, the controllable sensing parameters are selected from the group consisting of (i) polarization of the radiation 111, (ii) spectral intensity distribution of the radiation 111, (iii) angle of incidence of the radiation 111, (iv) pulse modulation and/or pulse frequency, and (v) polarization filter 215 upstream of a detector 210 of the sensing apparatus 200.

In embodiments, the control system 300 may be configured to determine from the initial mode of operation at least two different types of radiation 111 wherein a first type of radiation 1111 has a larger penetration depth in an plant object being sensed than a second type of radiation 1112, and to execute the one or more of one or more time-of-flight sensing modes of operation with the at least two different types of radiation 111 (see e.g. also FIG. 2a (variant II) wherein different optical properties for differ plant parts are schematically depicted).

FIG. 4b schematically depicts an embodiment of the sensing system 1000 further comprising a sensor 310. The sensor may especially comprise an optical sensor such as a camera. Also a plurality of (different types of) sensors may be applied. Further, FIG. 4b also very schematically depicts an embodiment of an agricultural facility 2000. The agricultural facility 2000, such as a greenhouse, may comprise the sensing system 1000. In specific embodiments, one or more of the radiation generator 100 and the sensing apparatus 200 are configured movable. Here, both may move, or may be moved, along rails. Especially, the control system 300 may be configured to control one or more of (i) a position of the radiation generator 100 and (ii) a position of the sensing apparatus 200. Optionally, also the sensor 310 may be configured movable. Alternatively or additionally, the sensor 310 may be comprised by one or more of the radiation generator 100 and the sensing apparatus 200. Note that the sensor 310 is different from the sensing devices.

As schematically depicted in FIG. 4b, in embodiments both the radiation generator 100 and the sensing apparatus 200 may be configured movable relative to each other.

As indicated above, the control system 300 is configured to execute an action in dependence of the sensing system signal, wherein the action is selected from the group consisting of controlling growing conditions of a plant, controlling irradiation of a plant or plant part, controlling harvesting of a plant or a plant part, controlling treatment of a plant, and controlling pruning of a plant; and wherein the agricultural facility 2000 is selected from the group consisting a horticulture arrangement, a greenhouse, and an open field.

Very schematically, an embodiment of a possible agricultural device 2100 is depicted, such as e.g. an irrigation and nutrient providing (spraying) system. The sensing system 1000 may be functionally coupled to such agricultural device 2100. The agricultural device 2100 is controllable in dependence of the sensing system signal. Of course, also other types of agricultural devices may alternatively or additionally be applied.

Hence, the invention also provides a plant monitor method, comprising executing a time-of-flight sensing mode of operation, wherein the method comprises subjecting one or more plants to a pulse of radiation 111, sensing radiation received by a sensing apparatus as function of time in the time-of-flight sensing mode of operation, and generating a sensing system signal, and wherein the method comprises executing the time-of-flight sensing mode of operation with the sensing system 1000 as described herein. Such plant monitor method may further comprise executing an action in dependence of the sensing system signal, wherein the action is selected from the group consisting of controlling growing conditions, controlling harvesting, controlling treatment, and controlling pruning.

FIG. 4c schematically depict an embodiment in variant I wherein the field of view (FoV) of the sensor system 200 overlaps at specific distances with the (beam of) radiation 111 of the radiation generator 100. Here, by way of example a focused beam of radiation 111 is depicted as a diverging sensing range. However, also the sensing apparatus may use optics such that e.g. a focal point of the radiation generator 100 and a focal point of the sensing apparatus 200 may overlap. The radiation 111 has a beam cross-section A1. The sensing apparatus 200 has a field of view cross-section A2 (in one or more of the one or more time-of-flight sensing modes of operation). Hence, at one or more distances these may at least partly overlap, which is the case in variant I. In variant I, distance dl indicates a distance from (an entrance window 205 of) the sensing apparatus 200 where the (beam of) radiation 111 of the radiation generator 100 and the field of view (FoV) of the sensor system 200 overlap. The distance d1 may be a range, below which there is no overlap, and above which, there is also no overlap. FIG. 4c, variant I, indicates the lowest value for d1.

In variant II the sensing system 1000 is used in such a way that the radiation generator 100 and the sensing apparatus 200 have a predetermined configuration wherein within a predetermined distance d2 from an entrance window 205 of the sensing apparatus 200 the beam cross-section A1 and the field of view cross-section A2 do not overlap, wherein the predetermined distance d2 is selected from the range of 0-500 cm. In such embodiment, also transmission and/or absorption in the plant object 1 of the radiation 111 may be sensed.

Of course, other embodiments than schematically depicted may be possible.

FIG. 4d schematically depict some phenomena that may occur upon irradiating a plant object 1 with radiation 111. Further, two or more of these may occur together. Variant I indicates transmission, variant II indicates reflection; variant III indicates scattering, and variant IV indicates luminescence. Note that perpendicular radiation may also lead to reflection and/or scattering. Further, irradiation under an angle may in embodiments also lead to (some) transmission and/or luminescence.

FIG. 4e schematically depicts two figures explaining some phenomena.

Assume that a plant object is irradiated with narrow beam radiation 111, indicated also with reference 111a. The radiation measured by the sensing apparatus may be indicated with radiation 111b, which may be lower in intensity due to one or more of absorption (see the absorption curve A) and scattering and/or reflection outside the field of view of the sensing system. Absorption may lead to loss of light (and/or to conversion; see also below).

Assume that a plant object is irradiated with broad band radiation 111, indicated also with reference 111c. The radiation measured by the sensing apparatus may be indicated with radiation 111d, which may be lower in intensity due to one or more of absorption (see the absorption curve A) and scattering and/or reflection outside the field of view of the sensing system. Absorption may lead to loss of light (or to conversion; see also below). Further, as the absorption is wavelength dependent, the sensed radiation 111d may have another wavelength dependence than the radiation 111c used for irradiation.

Assume that a plant object is irradiated with narrow beam radiation 111, indicated also with reference 111e in variant II. The radiation measured by the sensing apparatus may be indicated with radiation 111f, which may be lower in intensity due to one or more of absorption (see the absorption curve A) and scattering and/or reflection outside the field of view of the sensing system. Absorption may lead to loss of light and/or to conversion; here, also emission radiation 111g is schematically depicted. Hence, in embodiments irradiation with radiation 111 (here indicated as 111e) may lead to some reflection and/or scattering and/or transmission, and (some) luminescence (indicated with reference 1110.

Hence, in embodiments the invention may provide an optical range sensor with active illumination optimized to observe plants and fruits to extract 3D and spectral information simultaneously, wherein one or more of a (i) a single or multi-pixel (array/matrix) time-of-flight imager, (b) a laser scanner, and (c) a solid state LIDAR, may be applied. In embodiments, multi-spectral active illumination for time-of-flight ranging may be applied, wherein one or more of the following may be applied: (i) an optical sensor responsive to a wide spectrum in combination with an active light source with one or multiple monochromatic wavelengths that are activated sequentially, and (ii) two or more sensing elements with different optical filters or different spectral sensitivity to have different spectral response in combination with an active light source with a broad spectral range. Hence, also a combination may be applied. In embodiments monochromatic/multi-spectral active illumination using wavelengths matched to the reflective and/or transmissive optical properties of the fruit/plant may be applied, which may enable one or more following functionalities: (i) improvement of the signal quality of the range measurement, (ii) providing spectral information with range information, (iii) seeing through leaves functionality, (iv) classification between fruit/leaves based on spectral reflectance of single or multiple wavelengths, (v) assessment of plant development, plant health and detection of diseases based on spectral reflectance of single or multiple wavelengths, etc. In embodiments, monochromatic/multi-spectral active illumination using wavelengths matched to the reflective optical properties of the fruit/plant with 3D surface reconstruction may be applied, enabling one or more of the following functionalities: (i) scatter/bidirectional reflection distribution function measurement, (ii) reflectance properties measurement, (iii) polarization properties measurement, etc. In embodiments, monochromatic/multi-spectral active illumination using wavelengths matched to the transmissive optical properties of the fruit/plant with 3D surface reconstruction enabling the following functionalities: (i) scattering properties, (ii) penetration depth in material of specific wave lengths, etc. In embodiments, an algorithm may be provided and/or used, which may use the measured reflective and transmissive properties for specific wavelengths and reconstructed shape properties to extract one or more of the following information: (i) health status, (ii) growth/development status, (iii) absence/presence of diseases, (iv) ripeness, etc. Additionally or alternatively, the spectral and shape properties of the plant under inspection can be provided to a plant management system that can be used to create historical overview and trends and optimize the growth cycle and detect anomalies. Additionally or alternatively, the spectral and shape properties of the plant under inspection can be used to autonomously judge the quality of e.g. a fruit and guide a robot/drone in the actuation of picking such qualified fruit through the shielding leaf canopy. Amongst others, the invention may be applied for e.g. one or more of growth monitoring, quality monitoring, crop and fruit evaluation, property evaluation, fruit harvesting, making use of the lighting infrastructure instalment and functionality.

Range information (or distance information) can be used for example to compensate signal dampening depending on the measured distance. Similarly, the shape information derived from a pixelated or scanning ToF solution can be used to for example take into account the incident angle with respect to the surface of the active illumination.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” includes also embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A sensing system comprising a radiation generator, a sensing apparatus, and a control system functionally coupled to the radiation generator and the sensing apparatus, wherein the sensing system has one or more time-of-flight sensing modes of operation, wherein the generator is configured to generate a pulse of radiation in the one or more time-of-flight sensing modes of operation, and wherein the sensing apparatus is configured to sense wavelength dependent spectral intensities of radiation received by the sensing apparatus as a function of time in the one or more time-of-flight sensing modes, to provide a sensing system signal;
wherein the sensing system signal is indicative of the wavelength dependent spectral intensity distribution of the received radiation as a function of time in the one or more time-of-flight sensing modes;
wherein the radiation generator and the sensing apparatus are configured movable relative to each other.

2. The sensing system according to claim 1, wherein the sensing system is functionally coupled to an agricultural device, wherein the agricultural device comprises a lighting device for illuminating a plant or plant part with a light recipe, wherein the control system controls the agricultural device to illuminate the plant or plant part with the light recipe in dependence of the sensing system signal.

3. The sensing system according to claim 1, wherein the generator is configured to generate in one or more of the one or more time-of-flight sensing modes of operation a plurality of pulses of radiation wherein two or more pulses of radiation differ in angle of incidence of the radiation.

4. The sensing system according to claim 1, wherein the generator is configured to generate in one or more of the one or more time-of-flight sensing modes of operation a plurality of pulses of radiation wherein two or more pulses of radiation differ in optical properties, wherein the optical properties are selected from the group consisting of polarization, and spectral intensity distribution.

5. The sensing system according to claim 2, wherein the radiation generator comprises two or more lasers configured to generate radiation having different spectral intensity distributions and wherein the generator is configured to generate in one or more of the one or more time-of-flight sensing modes of operation a plurality of pulses of radiation with the two or more lasers.

6. The sensing system according to claim 2, wherein the radiation generator is configured to generate radiation in one or more of the one or more time-of-flight sensing modes of operation having a wavelength selected from the wavelength ranges of 200-300 nm, 680-720 nm, 920-960 nm, 1080-1120 nm, 1340-1420 nm, and 1850-1890 nm.

7. The sensing system according to claim 1, wherein the sensing system includes one or more controllable sensing parameters, wherein the sensing system has an initial mode of operation wherein a value of the one or more controllable sensing parameters are defined in dependence of one or more of user input information, a sensor signal of a sensor, and radiation received in a preliminary time-of-flight sensing mode of operation, and wherein the sensing system is configured to execute one or more of one or more time-of-flight sensing modes of operation with the defined sensing parameters after executing the initial mode of operation.

8. The sensing system according to claim 7, wherein the controllable sensing parameters are selected from the group consisting of polarization of the radiation, spectral intensity distribution of the radiation, angle of incidence of the radiation, pulse modulation and/or pulse frequency, and polarization filter upstream of a detector of the sensing apparatus.

9. The sensing system according to claim 7, wherein the control system is configured to determine from the initial mode of operation at least two different types of radiation wherein a first type of radiation has a larger penetration depth in an plant object being sensed than a second type of radiation, and to execute the one or more of one or more time-of-flight sensing modes of operation with the at least two different types of radiation.

10. The sensing system according to claim 1, wherein the radiation has a beam cross-section, wherein the sensing apparatus has a field of view cross-section, wherein the radiation generator and the sensing apparatus have a predetermined configuration wherein within a predetermined distance from an entrance window of the sensing apparatus the beam cross-section and the field of view cross-section do not overlap, wherein the predetermined distance is selected from the range of 0-500 cm.

11. (canceled)

12. An agricultural facility comprising the sensing system according to claim 1, wherein one or more of the radiation generator and the sensing apparatus are configured movable, and wherein the control system is configured to control one or more of a position of the radiation generator and a position of the sensing apparatus.

13. The agricultural facility according to claim 12, wherein both the radiation generator and the sensing apparatus are configured movable relative to each other.

14. The agricultural facility according to claim 12, wherein the control system is configured to execute an action in dependence of the sensing system signal, wherein the action is selected from the group consisting of controlling growing conditions of a plant, controlling irradiation of a plant or plant part, controlling harvesting of a plant or a plant part, controlling treatment of a plant, and controlling pruning of a plant; and wherein the agricultural facility is selected from the group consisting a horticulture arrangement, a greenhouse, and an open field.

15. (canceled)
